(19) United States
(12) Patent Application Publication
(10) Pub. No.: US 2008/0256527 A1
(43) Pub. Date: Oct. 16, 2008

(54) METHOD OF GENERATING FIRMWARE UPDATE FILE, METHOD AND APPARATUS FOR UPDATING FIRMWARE BY USING THE FIRMWARE UPDATE FILE

(75) Inventors: Sun-nam Lee, Suwon-si (KR); Il-jun Lee, Yongin-si (KR); Jun-bum Shin, Suwon-si (KR); Sang-hong Lee, Seoul (KR); Ji-young Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Sumsung Electronics Co., Ltd., Suwon-si (KR)

(21) Appl. No.: 11/948,178

(22) Filed: Nov. 30, 2007

(30) Foreign Application Priority Data
Apr. 16, 2007 (KR) 10-2007-0037153

(51) Int. Cl. G06F 9/44

(52) U.S. Cl. 717/168

(57) ABSTRACT

Provided are a method of generating a firmware update file which restrictively allows a firmware update for a corresponding hardware model, and a method and apparatus for updating firmware using the firmware update file. By generating a data body including program codes of firmware to be updated, generating a data header including model codes of a hardware device to which the data body is applied, and generating the firmware update file by combining the data body and the data header, the firmware update may be restricted for a corresponding model of a hardware device by using the firmware update file so that firmware of other models of hardware devices may not be updated, an integrity check may be performed using a digital signature when the firmware is updated.

### CROSS-REFERENCE TO RELATED PATENT APPLICATION

This application claims priority from Korean Patent Application No. 10-2007-0037153, filed on Apr. 16, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to generating a firmware update file, and updating firmware by using the firmware update file, and more particularly, to generating a firmware update file which includes model codes of a hardware device to which the firmware is applied, and updating the firmware by using the model codes of the hardware device which are included in the firmware update file.

2. Description of the Related Art

Firmware is a program which controls and manages hardware. The firmware is different from the hardware because it is a program. However, the firmware is also different from a general application program because it is intimately related to the hardware. The firmware has characteristics of both hardware and software and, in general, is stored in flash memory such as read-only memory (ROM).

For example, when a hardware device is prepared to perform a function, if all control circuits are prepared with hardware, the structure of the hardware device has to be very complicated and some logics could not even be implemented easily. By replacing most parts of the hardware device with software and preparing a storage device in which the software is stored as a main portion of the hardware device, the above problems may be easily solved at low cost. The software which has characteristics of hardware is the firmware.

In the related art, a system, more particularly, an embedded system which performs a variety of functions, includes firmware for performing a corresponding function. The firmware is widely used for a small-scaled single program rather than a large-scaled program such as an operating system. The firmware, due to its small scale, needs to be updated from time to time in order to reduce firmware errors, to enhance system performance, and to add functions and the like.

When the firmware is updated, the firmware which was developed specifically to a certain hardware model may be used for another hardware model. For example, firmware of company A may be used for a set top box of company B.

Furthermore, region codes of the updated firmware may not be identical to those of the hardware device and thus disputes may occur and additional costs may be incurred due to wrong firmware update.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

The present invention provides a method of generating a firmware update file which allows update of a firmware to be restrictive for a corresponding hardware model, and a method and apparatus for updating firmware by using the firmware update file.

According to an aspect of the present invention, there is provided a method of generating a firmware update file, the method including generating a data body which includes program codes of firmware to be updated; generating a data header which includes model codes of a hardware device to which the data body is applied; and combining the data body and the data header.

The data header may further include region codes of the hardware device.

The region codes of the hardware device may include at least one of free codes, continental codes, and nation codes.

The data header may further include version information of the program codes included in the data body.

The method may further include generating a digital signature which identifies the data body and the data header.

The method may further include encrypting the data body.

According to another aspect of the present invention, there is provided a method of amending software of a device, the method including reading a data header included in a firmware update file; reading out first codes from the data header, wherein the first codes designate a model of a hardware device to which the firmware update file is applied; reading out second codes from the hardware device, wherein the second codes designate the model of the hardware device; comparing the first codes and the second codes; and updating a firmware of the hardware device based on the result of the comparing of the first and second codes.

Reading the data header may include parsing the firmware update file into the data header, a data body which includes program codes of the firmware to be updated, and a digital signature which identifies the data header and the data body.

The method may further include authenticating the digital signature, wherein the updating of the firmware is performed when the authenticating of the digital signature is successfully performed.

The updating the firmware may be performed only when the first and second codes are identical to each other.

The updating the firmware may include reading out region codes of the hardware device to which the firmware update file is applied, from the data header; and determining whether to update the firmware by comparing the region codes read out from the data header and region codes of the hardware device which are included in the hardware device.

The updating of the firmware may further include determining whether to update the firmware by comparing version information of the firmware which is previously set in the hardware device and version information included in the data header.

According to another aspect of the present invention, there is provided a computer readable recording medium having recorded thereon a data structure of a firmware update file including a data body which includes program codes of firmware to be updated, and a data header which includes model codes and region codes of a hardware device to which the data body is applied.

According to another aspect of the present invention, there is provided a computer readable recording medium having recorded thereon a data structure of a firmware update file including a data body which includes program codes of firmware to be updated, a data header which includes model codes and region codes of a hardware device to which the data body is applied, and a digital signature for the data body and the data header.

According to another aspect of the present invention, there is provided a computer readable recording medium having recorded thereon a computer program for executing a method of generating a firmware update file, the method including generating a data body which includes program codes of firmware to be updated; generating a data header which includes model codes of a hardware device to which the data body is applied; and combining the data body and the data header.

According to another aspect of the present invention, there is provided a computer readable recording medium having recorded thereon a computer program for executing a method of amending software of a device, the method including reading a data header included in the firmware update file; reading out first codes which designate a model of a hardware device to which the firmware update file is applied, from the data header; comparing the first codes and second codes which are included in the hardware device and designate a model of the hardware device; and updating the firmware of the hardware device based on the result of the comparing of the first and second codes.

According to another aspect of the present invention, there is provided an apparatus for generating a firmware update file, the apparatus including a firmware generation unit for generating a data body which includes program codes of a firmware to be updated; a header generation unit for generating a data header which includes model codes of a hardware device to which the data body is applied; and a combination unit for generating the firmware update file by combining the data body and the data header.

According to another aspect of the present invention, there is provided an apparatus for amending software of a device, the apparatus including a header reading unit for reading a data header included in a firmware update file; a model distinction unit for reading out first codes from the data header, wherein the first codes designate a model of a hardware device to which the firmware update file is applied, wherein the model distinction unit reads out second codes from the hardware device, wherein the second codes designate the model of the hardware device; a model comparison unit for comparing the first codes and second codes; and an update unit for updating the firmware of the hardware device based on the result of the comparing of the first and second codes.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart of a method of generating a firmware update file, according to an exemplary embodiment of the present invention;

FIG. 2 is a flowchart of a method of generating a firmware update file, according to another exemplary embodiment of the present invention;

FIG. 3 is a flowchart of a method of updating firmware by using a firmware update file, according to an exemplary embodiment of the present invention;

FIG. 4 is a flowchart of a method of updating firmware by using a firmware update file, according to another exemplary embodiment of the present invention;

FIG. 5 is a diagram illustrating a data structure of a firmware update file, according to an exemplary embodiment of the present invention;

FIG. 6 is a table illustrating specifications of codes included in a hardware device and a firmware update file, according to an exemplary embodiment of the present invention;

FIG. 7 is a functional block diagram of an apparatus for generating a firmware update file, according to an exemplary embodiment of the present invention; and

FIG. 8 is a functional block diagram of an apparatus for generating a firmware update file, according to another exemplary embodiment of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining embodiments of the invention with reference to the attached drawings.

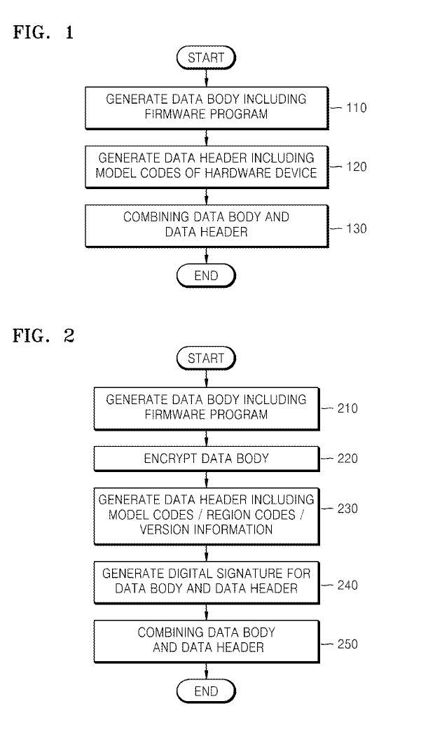

FIG. 1 is a flowchart of a method of generating a firmware update file, according to an exemplary embodiment of the present invention.

Referring to FIG. 1, the method includes generating a data body which includes program codes of firmware to be updated (operation 110), generating a data header which includes model codes of a hardware device to which the data body is applied (operation 120), and generating the firmware update file by combining the data body and the data header (operation 130).

In particular, a data body, which includes a firmware program which controls and manages a hardware device, is generated in operation 110. Substantial program codes of firmware are recorded in the data body of the firmware update file (also referred to as a ROM update file).

A data header is generated to be added to the data body in operation 120. A model name of the hardware device to which the firmware is applied is included in the data header. Thus, each firmware update file has a data structure designed to be installed to a certain hardware device in accordance with the model codes included in the data header.

The firmware update file is generated by combining the data body and the data header in operation 130.

Also, the data header may selectively further include version information or region codes which designate an allowable region of the hardware device, and a digital signature may be added to authenticate, i.e., prevent forgery of, the firmware update file. Alternatively, the program codes of the data body may be encrypted and stored. A method of generating a firmware update file by encrypting the data body will now be described in detail with reference to FIG. 2.

FIG. 2 is a flowchart of a method of generating a firmware update file, according to another exemplary embodiment of the present invention.

Referring to FIG. 2, a data body, which includes program codes of firmware to be updated, is generated in operation 210 as in operation 110 of the previous exemplary embodiment. Here, raw codes of the program codes may not be directly stored but the raw codes may be encoded and stored for security in operation 220. In this case, the program codes of the firmware which are included in the data body are encrypted themselves. As such, by performing encryption in order to prevent any modification of a firmware program, the firmware is guaranteed to operate normally as intended when the firmware is made after the firmware is installed to the hardware later.

Then, a data header is generated in operation 230. Here, model codes of the hardware are included in the data header and region codes and version information may further be included. The region codes designate an allowable region of a corresponding hardware device. For example, if the hardware device is exported to a country such as the United States, nation codes which designate the United States are recorded as the region codes. Alternatively, in order to designate the allowable region more broadly, continental codes or free codes which unconditionally allow every region may be recorded as the region codes. The nation codes, the continental codes, and the free codes may be recorded separately or in combination.

The version information indicates the version of the program codes included in the data body of the firmware update file. The version information may vary in accordance with the date when the firmware program is made, modification of the firmware program, an application model of the firmware program, and the like.

Then, a digital signature is generated to authenticate, i.e., prevent forgery of, the data body or the data header in operation 240. The digital signature is generated in order to encrypt the firmware update file and enable user authentication, message integrity check (MIC), and non-repudiation when the firmware is updated later.

The digital signature may be generated by using a public-key encryption algorithm or a hash function. The public key encryption algorithm is used in an asymmetric encryption system in which an encryption key is different from a decryption key. A transmitter encrypts data by using its own secret key and a public key of a receiver and transmits the data, and the receiver decrypts the data by using its own secret key and a public key of the transmitter. In general, the asymmetric encryption system is used for distribution of an encryption key or a session key, or a digital signature rather than encryption of message contents. The hash function converts a certain message into a message digest having a predetermined length. The hash function is unidirectional (i.e., irreversible) so that the original message may not be obtained from the message digest and stochastically, different original messages may not have the same message digest. Thus, the hash function may used to check whether a message is authentic. Popular hash functions include message digest algorithm 5 (MD5) and secure hash algorithm (SHA).

Lastly, the firmware update file is generated by combining the data body and the data header and adding the above-described digital signature thereto in operation 250.

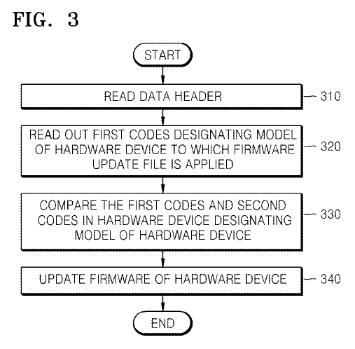

FIG. 3 is a flowchart of a method of updating firmware by using a firmware update file, according to an exemplary embodiment of the present invention.

Referring to FIG. 3, the method includes reading a data header included in the firmware update file (operation 310), reading out first codes which designate a model of a hardware device to which the firmware update file is applied, from the data header (operation 320), comparing the first codes and second codes which are included in the hardware device and designate a model of the hardware device (operation 330), and updating the firmware of the hardware device based on the result of the comparing of the first and second codes (operation 340).

In more detail, a data header of the firmware update file is read because various information on a hardware device to which the firmware is applied is stored in the data header in operation 310.

Consequently, model codes (first codes) which designate a model of the hardware device are read out from the data header in operation 320, and the first codes are compared with model codes (second codes) which are included in the hardware device in operation 330.

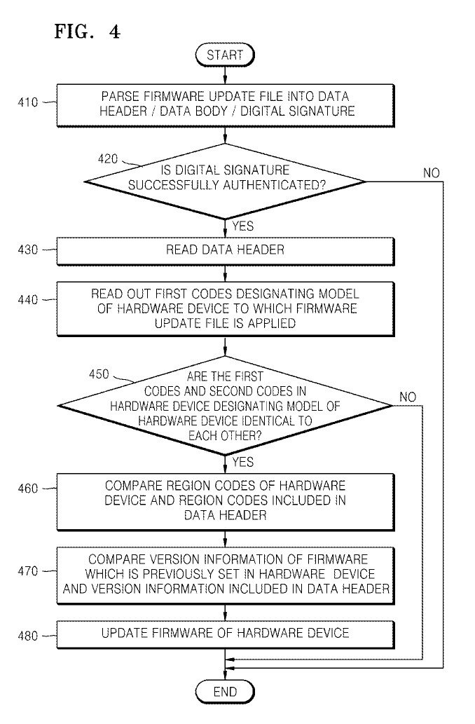

Based on the result of the comparing of the first and second codes, the determination is made in operation 340 on whether to update the firmware of the hardware device. Specifically, if a compatibility-related condition of the model codes is satisfied, for example, if the model codes designate the same model name, the updating the firmware is continuously performed. The method of updating the firmware will now be described in detail with reference to the flowchart illustrated in FIG. 4.

FIG. 4 is a flowchart of a method of updating firmware by using a firmware update file, according to another exemplary embodiment of the present invention.

Referring to FIG. 4, the firmware update file is parsed into a data header, a data body, and a digital signature in operation 410.

Then, the digital signature is decrypted. For example, the decrypting is performed by using a public key of a manufacturer of the firmware update file because if the digital signature is generated by using a public key encryption algorithm, an encryption system is an asymmetric encryption system in which an encryption key is different from a decryption key. As such, any users who know the public key of the manufacture may check the contents of the firmware update file and it is non-repudiatable that the manufacturer made the firmware update file. Accordingly, integrity of the firmware update file may be checked in operation 420.

If the digital signature is successfully authenticated, then the data header is read in operation 430 and model codes (first codes) included in the data header are read out in operation 440.

If the first codes are identical to second codes which designate a model of a hardware device in which the firmware to be updated is installed in operation 450, the updating of the firmware is performed by selectively further checking region codes and version information. That is, if the first and second codes are not identical to each other, the updating of the firmware is directly ended because the firmware update file is designed to update the firmware restrictively for a corresponding model.

If the first and second codes are determined to be identical, region codes separately included in the hardware device and the firmware update file are compared in operation 460. As described above, in a case of free codes, the operation unconditionally proceeds to a next operation, in a case of continental codes, it is determined whether a region designated by the region codes is included in a continental designated by the continental codes, and in a case of nation codes, it is determined whether regions designated by the two codes are exactly identical to each other.

By checking version information of the firmware which is previously set in the hardware device, whether to update the firmware may also be determined in operation 470. That is, the firmware may be updated only when the firmware update file is an upper version of the firmware. Then, the firmware is updated in operation 480.

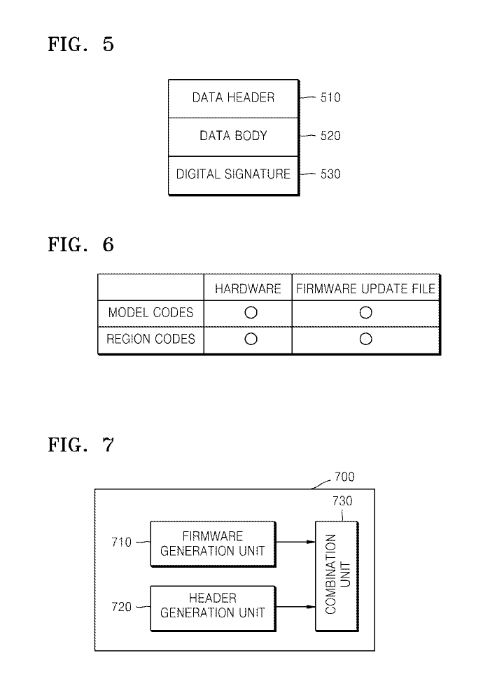

FIG. 5 is a diagram illustrating a data structure of a firmware update file, according to an exemplary embodiment of the present invention.

Referring to FIG. 5, as described above, the firmware update file includes a data header 510, a data body 520, and a digital signature 530.

FIG. 6 is a table illustrating specifications of codes included in a hardware device and a firmware update file, according to an exemplary embodiment of the present invention.

Referring to FIG. 6, a firmware update file includes model codes which designate a model of a hardware device which is allowed to be updated by using the firmware update file in addition to region codes which designate an available region of the hardware device to which the firmware is applied.

A hardware which needs to be updated according to the present invention also includes model codes and region codes.

FIG. 7 is a functional block diagram of an apparatus for generating a firmware update file, according to an exemplary embodiment of the present invention.

Referring to FIG. 7, the apparatus 700 includes a firmware generation unit 710 which generates a data body which includes program codes of firmware to be updated, and a header generation unit 720 which generates a data header which includes model codes of a hardware device to which the data body is applied. The apparatus further includes a combination unit 730 which generates the firmware update file by combining the data body generated by the firmware generation unit 710 and the data header generated by the header generation unit 720.

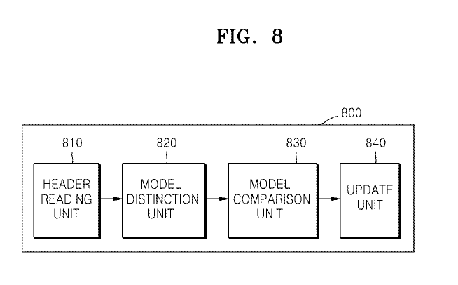

FIG. 8 is a functional block diagram of an apparatus for generating a firmware update file, according to another exemplary embodiment of the present invention.

Referring to FIG. 8, the apparatus 800 includes a header reading unit 810 which reads a data header included in the firmware update file, a model distinction unit 820 which reads out first codes which designate a model of a hardware device to which the firmware update file is applied, from the data header, a model comparison unit 830 which compares the first codes and second codes which are included in the hardware device and designate a model of the hardware device, and an update unit 840 which updates the firmware of the hardware device based on the result of the comparing of the first and second codes.

The exemplary embodiments of the present invention can be written as computer programs and can be implemented in general-use digital computers that execute the programs using a computer readable recording medium.

Also, a data structure used for a firmware update file according to the present invention can be recorded on a computer readable recording medium by using many different means.

Examples of the computer readable recording medium include magnetic storage media (e.g., ROM, floppy disks, hard disks, etc.), optical recording media (e.g., CD-ROMs, or DVDs), and other storage media.

As described above, in a method of generating a firmware update file, and a method and apparatus for updating firmware by using a firmware update file according to the present invention, the update of the firmware may be restricted for a corresponding model of a hardware device by using the firmware update file so that firmware of other models of hardware devices may not be updated. Thus, disputes between a manufacturer of a hardware device and a copyright holder of a firmware program may be prevented.

Furthermore, security may be strengthened by encrypting the firmware program, and due to a digital signature, an integrity check may be performed when the firmware is updated.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of generating a firmware update file, the method comprising:
generating a data body comprising program codes of firmware to be updated;
generating a data header comprising model codes of a hardware device to which the data body is applied; and
combining the data body and the data header.

2. The method of claim 1, wherein the data header further comprises region codes of the hardware device.

3. The method of claim 2, wherein the region codes of the hardware device comprise at least one of free codes, continental codes, and nation codes.

4. The method of claim 2, wherein the data header further comprises version information of the program codes of the data body.

5. The method of claim 1, further comprising generating a digital signature which authenticates at least one of the data body and the data header.

6. The method of claim 5, further comprising encrypting the data body.

7. A method of amending software of a hardware device, the method comprising:
reading a data header from a firmware update file;
reading first codes from the data header;
reading second codes from the hardware device;
comparing the first codes and the second codes; and
updating a firmware of the hardware device based on a result of the comparing of the first and second codes.

8. The method of claim 7, wherein reading the data header comprises parsing the firmware update file into the data header, a data body comprising program codes of the firmware to be updated, and a digital signature which authenticates at least one of the data header and the data body.

9. The method of claim 8, further comprising authenticating the digital signature, wherein the updating of the firmware is performed if the authenticating of the digital signature is successfully performed.

10. The method of claim 7, wherein the comparing the first codes and the second codes comprises comparing a first hardware model, which is specified in the first codes, with a second hardware model, which is specified in the second codes and corresponds to the hardware device.

11. The method of claim 7, wherein the updating the firmware is performed if the first and second codes are the same.

12. The method of claim 11, wherein the updating the firmware comprises:
reading region codes of the hardware device to which the firmware update file is applied, from the data header; and
determining whether to update the firmware by comparing the region codes read from the data header and region codes of the hardware device.

13. The method of claim 12, wherein the updating of the firmware further comprises determining whether to update the firmware by comparing version information of the firmware which is previously set in the hardware device and version information included in the data header.

14. A computer readable recording medium having recorded thereon a data structure of a firmware update file comprising a data body comprising program codes of firmware to be updated, and a data header comprising model codes and region codes of a hardware device to which the data body is applied.

15. An apparatus for generating a firmware update file, the apparatus comprising:
a firmware generation unit which generates a data body comprising program codes of a firmware to be updated;
a header generation unit which generates a data header comprising model codes of a hardware device to which the data body is applied; and
a combination unit which generates the firmware update file by combining the data body and the data header.

16. An apparatus for amending software of a hardware device, the apparatus comprising:
a header reading unit which reads a data header from a firmware update file;
a model distinction unit which reads first codes from the data header and reads second codes from the hardware device;
a model comparison unit which compares the first codes and second codes; and
an update unit which updates the firmware of the hardware device based on a result of the comparing of the first and second codes by the comparison unit.

17. The apparatus of claim 16, wherein the comparison unit compares a first hardware model, which is specified in the first codes, with a second hardware model, which is specified in the second codes and corresponds to the hardware device.
